(19) United States
(12) Patent Application Publication
(10) Pub. No.: US 2020/0047436 A1
(43) Pub. Date: Feb. 13, 2020

(54) FILLER-RESIN COMPOSITE, METHOD FOR PRODUCING FILLER-RESIN COMPOSITE, FILLER-RESIN COMPOSITE LAYER, AND METHOD FOR USING FILLER-RESIN COMPOSITE

(71) Applicant: HITACHI ZOSEN CORPORATION, Osaka-shi, Osaka (JP)

(72) Inventors: Hiroyuki MARUYAMA, Osaka-shi, Osaka (JP); Tetsuya INOUE, Osaka-shi, Osaka (JP)

(21) Appl. No.: 16/498,287

(22) PCT Filed: Jan. 10, 2018
(86) PCT No.: PCT/JP2018/000344

§ 371 Date: Sep. 26, 2019

(30) Foreign Application Priority Data
Mar. 31, 2017 (JP) 2017-072258

(51) Int. Cl. B29C 70/58; B29C 65/00; C08L 19/00; C08K 3/04; B29C 65/48

(52) U.S. Cl. CPC B29C 70/58; B29C 66/72323; B29C 65/4825; C08K 3/041; C08L 19/00

(57) ABSTRACT

A filler-resin composite includes a filler layer in which filler is assembled, a resin layer in which resin is charged in at least one end portion of the filler layer in the thickness direction and a distal end of the one end portion of the filler layer is exposed, and a release member laminated on the resin layer, wherein the release member can be released from the resin layer.

### TECHNICAL FIELD

The present invention relates to a filler-resin composite, a method for producing a filler-resin composite, a filler-resin composite layer, and a method for using a filler-resin composite.

### BACKGROUND ART

Conventionally, as a composite of filler and resin, a transfer body in which vertically-aligned carbon nanotube group and a thermoplastic resin film are integrated has been known (ref: Patent Document 1 below).

The transfer body includes the vertically-aligned carbon nanotube group transferred from a growth substrate to the thermoplastic resin film, and is produced by embedding or penetrating the distal end portion (end portion not in contact with growth substrate) of the carbon nanotube group on the growth substrate to the thermoplastic resin film, and then the growth substrate is removed, and the carbon nanotube group is impregnated with an impregnant.

### CITATION LIST

### Patent Document

### Patent Document 1: Japanese Unexamined Patent Publication No. 2010-240871

### SUMMARY OF THE INVENTION

### Problem to be Solved by the Invention

However, with the method for producing a composite of filler and resin described in the above-described Patent Document 1, the distal end portion of the carbon nanotube group is embedded or penetrated in the thermoplastic resin film, and therefore when only the thermoplastic resin film is released off from the composite material of the integrated carbon nanotube group, thermoplastic resin film, and impregnant, the thermoplastic resin film, and the carbon nanotube group embedded or penetrated in the thermoplastic film may damage the impregnant. Therefore, it is difficult to control the exposure of the distal end of the carbon nanotube of the composite. Also, the carbon nanotube group in the composite is embedded or penetrated in the thermoplastic resin film, and therefore there are disadvantages in that when the thermoplastic resin film is peeled off, the distal end of the carbon nanotube group remained in the thermoplastic resin film is ripped off, thereby shortening the length of the carbon nanotube group.

Also, the composite of filler and resin as described in the above-described Patent Document 1 is thin and easily tear, and therefore improvement in handleability is required even more.

Thus, an object of the present invention is to provide a filler-resin composite with which exposure of the distal end of the one end portion of the filler layer can be easily controlled, and with improved handleability; and a method for producing a filler-resin composite.

### Means for Solving the Problem

The present invention [1] includes a filler-resin composite including a filler layer in which filler is assembled, a resin layer in which resin is charged in at least one end portion of the filler layer in the thickness direction and a distal end of the one end portion of the filler layer is exposed, and a release member laminated on the resin layer, wherein the release member can be released from the resin layer.

The present invention [2] includes the filler-resin composite of the above-described [1], wherein the resin layer is separately charged at one end portion and the other end portion of the filler layer in the thickness direction, and the release member is laminated on the one end portion and the other end portion of the resin layer.

The present invention [3] includes the filler-resin composite of the above-described [1] or [2], wherein the filler layer is vertically-aligned carbon nanotube.

The present invention [4] includes a method for producing a filler-resin composite, the method including the steps of: a first preparation step, in which a filler layer is prepared; a second preparation step, in which a release member to which resin is applied is prepared; a lamination step, in which the release member is laminated on the filler layer so that the resin contacts at least one end portion of the filler layer in the thickness direction; and a solidifying step, in which a distal end of the one end portion of the filler layer is exposed, and the resin is solidified to form a resin layer.

The present invention [5] includes a method for producing a filler-resin composite, the method including the steps of: a first preparation step, in which a filler layer is prepared; a second preparation step, in which, a release member to which resin is applied, and a second release member to which resin is applied are prepared; a lamination step, in which the release member is laminated on the filler layer so that the resin of the release member contacts one end portion of the filler layer in the thickness direction, and the second release member is laminated on the filler layer so that the resin of the second release member contacts the other end portion of the filler layer in the thickness direction; and a solidifying step, in which the distal end of the one end portion and the other end portion of the filler layer is exposed, and the resin is solidified to form a resin layer at the one end portion and the other end portion of the filler layer in the thickness direction.

The present invention [6] includes a method for producing a filler-resin composite, the method including the steps of: a preparation step, in which a filler layer is prepared on a substrate; a first lamination step, in which a first release member to which resin is applied is laminated on the opposite side of the substrate relative to the filler layer so that the resin contacts one end portion of the filler layer in the thickness direction; a first solidifying step, in which the distal end of the one end portion of the filler layer is exposed, and the resin is solidified to form a resin layer at the one end portion of the filler layer in the thickness direction; and a substrate removal step, in which the substrate is removed.

The present invention [7] includes a method for producing a filler-resin composite of the above-described [6], the method including the steps of: a second lamination step, in which a second release member to which resin is applied is laminated on the opposite side of the first release member relative to the filler layer so that the resin contacts the other end portion of the filler layer in the thickness direction; and a second solidifying step, in which a distal end of the other end portion of the filler layer is exposed, and the resin is solidified to form a resin layer on the other end portion of the filler layer in the thickness direction.

The present invention [8] includes a filler-resin composite layer including a filler layer and a first resin layer, in which resin is charged in at least one end portion of filler layer in the thickness direction, and a distal end of the one end portion of the filler layer is exposed, wherein the distal end of the one end portion of the filler layer is flush with the interface of the first resin layer.

The present invention [9] includes the filler-resin composite layer of the above-described [8], further including a second resin layer, in which resin is charged in the other end portion of the filler layer in the thickness direction and a distal end of the other end portion of the filler layer is exposed, wherein the distal end of the other end portion of the filler layer is flush with the interface of the second resin layer, and the first resin layer is separated from the second resin layer at one end portion and the other end portion of the filler layer in the thickness direction.

The present invention [10] includes the method for using a filler-resin composite of the above-described [1], the method including the steps of: a release step, in which the release member is released from the resin layer; and a attaching step, in which the released resin layer having pressure-sensitive adhesiveness contacts a member to be attached.

### Effects of the Invention

The filler-resin composite of the present invention is protected by the release member, and therefore external contamination and damages to the filler-resin composite layer can be prevented, and handleability of the filler-resin composite layer can be improved.

The method for producing a filler-resin composite allows the distal end of the one end portion of the filler layer to easily expose from the resin.

### BRIEF DESCRIPTION OF THE DRAWINGS

FIG. 1 is a cross sectional view illustrating a filler-resin composite of a first embodiment of the present invention.

FIG. 2A to FIG. 2C illustrate the method for using a filler-resin composite as shown in FIG. 1, FIG. 2A illustrating a step of preparing a filler-resin composite, FIG. 2B illustrating a step of releasing the first release member from the filler-resin composite layer following FIG. 2A, and FIG. 2C illustrating a step of allowing one side surface of the filler-resin composite layer in the thickness direction to contact a heat sink, following FIG. 2B.

FIG. 3A and FIG. 3B illustrate the method for using a filler-resin composite following FIG. 2C, FIG. 3A illustrating a step of releasing the second release member from the filler-resin composite layer following FIG. 2C, FIG. 3B illustrating a step of allowing a heating element to contact the other side surface of the filler-resin composite layer in the thickness direction following FIG. 3A.

FIG. 4A to FIG. 4C illustrate the method for producing a filler-resin composite shown in FIG. 1, FIG. 4A illustrating a first preparation step, FIG. 4B illustrating a second preparation step following FIG. 4A, and FIG. 4C illustrating a lamination step following FIG. 4B.

FIG. 5A and FIG. 5B illustrate the method for producing a filler-resin composite following FIG. 4C. FIG. 5A shows, in the curing step, the following: the thermosetting resin in B-stage melts, the one end portion and the other end portion of the filler layer in the thickness direction are impregnated with the melted thermosetting resin, one end portion of the filler layer in the thickness direction contacts the first release member, and the other end portion of the filler layer in the thickness direction contacts the second release member. FIG. 5B shows, in the curing step, the following: the thermosetting resin is cured, and the first resin layer and the second resin layer are formed.

FIG. 6 is a cross sectional view of the filler-resin composite of a modified example.

FIG. 7A and FIG. 7B illustrate the method for producing a filler-resin composite shown in FIG. 6, FIG. 7A illustrating a lamination step, and FIG. 7B illustrating a curing step.

FIG. 8 is a cross sectional view of the filler-resin composite in the second embodiment.

FIG. 9A to FIG. 9 D illustrate the method for producing a filler-resin composite shown in FIG. 8, FIG. 9A illustrating a preparation step, FIG. 9B illustrating a first lamination step following FIG. 9A, FIG. 9C illustrating a first curing step following FIG. 9B, and FIG. 9D illustrating a substrate removal step following FIG. 9C.

FIG. 10A and FIG. 10B illustrate the method for producing a filler-resin composite shown in FIG. 9D, FIG. 10A illustrating a second lamination step following FIG. 9D, and FIG. 10B illustrating a second curing step following FIG. 10A.

FIG. 11 illustrates a modified example of the second embodiment.

FIG. 12 is a scanning electron microscope image of the filler-resin composite layer of the filler-resin composite produced in Example 1.

FIG. 13 is a correlation diagram showing relationship between the thermal resistance and pressure in Comparative Example, Example 1, and Example 2.

### DESCRIPTION OF THE EMBODIMENTS

(Filler-Resin Composite)

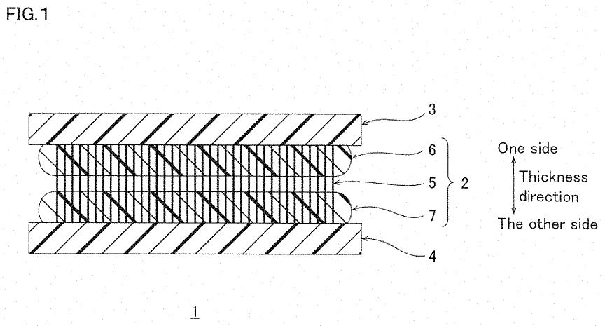

FIG. 1 is a schematic diagram of a filler-resin composite 1 of the first embodiment of the present invention. The filler-resin composite 1 includes a filler-resin composite layer 2, a first release member 3 as an example of the release member, and a second release member 4 as an example of the release member.

The filler-resin composite layer 2 includes a filler layer 5, a first resin layer 6 as an example of the resin layer, and a second resin layer 7 as an example of the resin layer.

The filler layer 5 is a layer in which a plurality of fillers assembled densely. In the filler layer 5, one filler is in contact with the plurality of fillers from the one end face to the other end face of the filler layer 5 in the thickness direction, and for example, in the thickness direction, heat can be conducted from the one end face to the other end face of the filler layer 5. The filler layer 5 can give desired characteristics to the filler-resin composite layer 2 depending on the filler characteristics. Examples of the filler characteristics include rigidity, electrical conductivity, thermal conductivity, and electromagnetic wave absorption. The filler preferably has thermal conductivity. The filler may have a plurality of types of characteristics.

Examples of the filler include, to be specific, carbon filler such as carbon nanotube and carbon fiber, and graphite; ceramics filler such as silica, aluminum oxide (alumina), zinc oxide, hexagonal boron nitride, and aluminum nitride; metal powder; and glass fiber.

Examples of the filler include preferably carbon filler, more preferably, carbon nanotube.

Carbon nanotube can be any of single-wall carbon nanotubes or multi-wall carbon nanotubes.

The filler shape can be spherical, flaky, or fibrous.

Preferably, the filler is fibrous, extending in the thickness direction of the filler layer 5. For example, the filler layer 5 is vertically-aligned carbon nanotubes, in which a plurality of carbon nanotubes (filler) extending in the thickness direction are arranged in a direction orthogonal to the thickness direction. The vertically-aligned carbon nanotube forms a layer by densely assembling a plurality of carbon nanotubes with van der Waals force. The filler layer 5 includes a plurality of filler assemblies separated from each other and arranged in dots. In particular, the filler layer 5 includes a plurality of vertically-aligned carbon nanotubes separated from each other and arranged in dots. The vertically-aligned carbon nanotube may be coated with a metal thin film. By coating the vertically-aligned carbon nanotube with a metal thin film, strength (and electrical conductivity) of the vertically-aligned carbon nanotube can be improved. The vertically-aligned carbon nanotube can be coated with a metal thin film by a method including a known vapor deposition.

The filler layer 5 has a thickness of, without particular limitation, for example, preferably 10 μm or more and 300 μm or less. That is, when the filler layer 5 is vertically-aligned carbon nanotubes, the thickness direction length of the carbon nanotube forming the filler layer 5 is preferably 10 μm or more. When the thickness direction length of the carbon nanotube forming the filler layer 5 is the above-described lower limit value or more, the filler-resin composite layer has excellent handleability. The thickness direction length of the carbon nanotube forming the filler layer 5 is preferably 300 μm or less. When the thickness direction length of the carbon nanotube forming the filler layer 5 is the above-described upper limit value or less, excessive increase in the production costs of the carbon nanotube can be suppressed.

The first resin layer 6 constrains the plurality of fillers by binding the plurality of fillers with each other. The first resin layer 6 fills at least one end portion of the filler layer 5 in the thickness direction. To be specific, the first resin layer 6 fills the gaps between the fillers at at least one end portion of the filler layer 5 in the thickness direction. The distal end of the one end portion of the filler layer 5 in the thickness direction is exposed from the first resin layer 6, and preferably, shares (flush with) the same surface. In other words, the distal end of the one end portion of the filler layer 5 in the thickness direction coincide with the interface between the first resin layer 6 and the first release member 3.

The first resin layer 6 has a thickness of the filler layer 5 or less, and for example, preferably 5 μm or more. When the thickness of the first resin layer 6 is the above-described lower limit value or more, mechanical strength of the filler-resin composite layer 2 can be ensured.

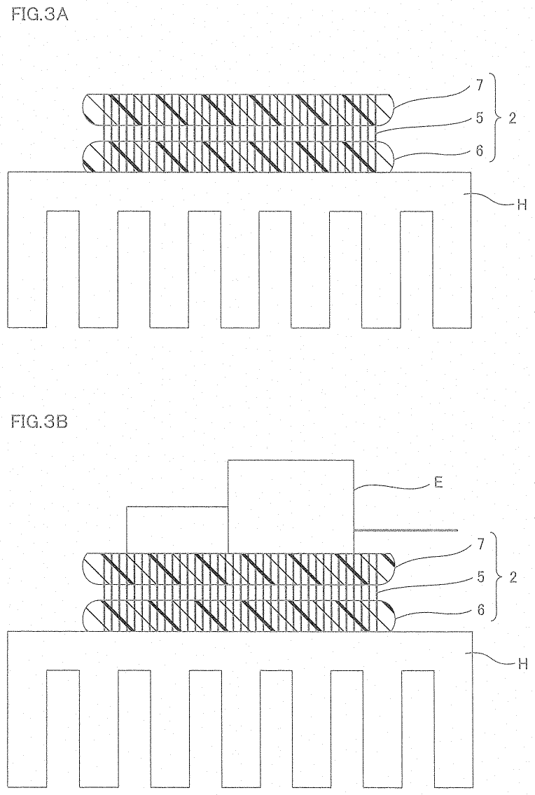

The first resin layer 6 preferably has pressure-sensitive adhesiveness. When the first resin layer 6 has pressure-sensitive adhesiveness, the first release member 3 can be attached to one side surface of the filler-resin composite layer 2 in the thickness direction. The first resin layer 6 can have pressure-sensitive adhesiveness to a degree that does not prevent the first release member 3 from released from the filler-resin composite layer 2. When the first resin layer 6 has pressure-sensitive adhesiveness, the filler-resin composite layer 2 can be easily attached to an object, such as a heat sink H (ref: FIG. 3B) to be described later.

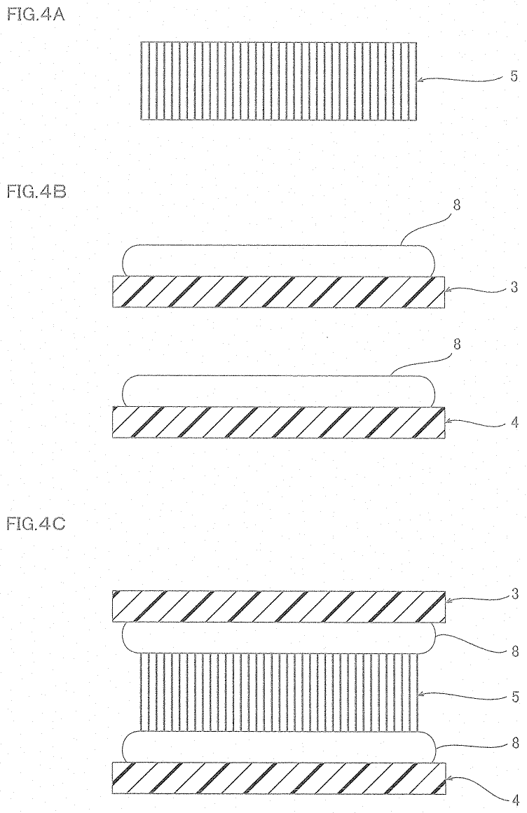

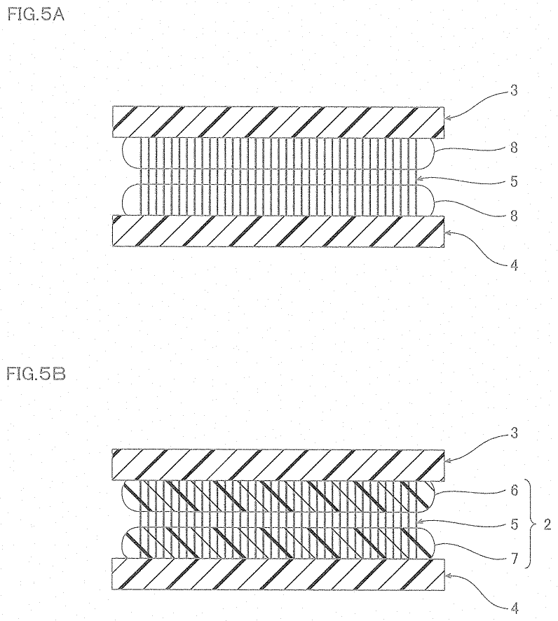

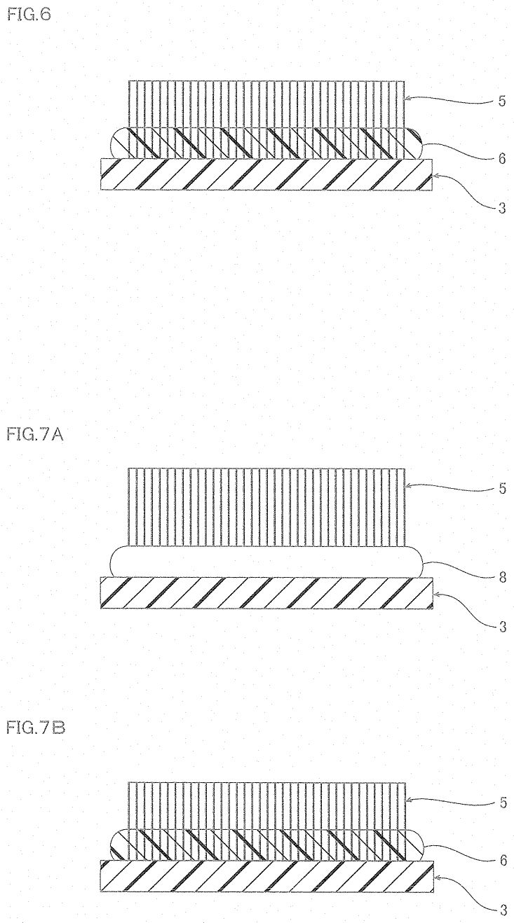

The first resin layer 6 can be any solidified resin, and for example, it can be solidified thermoplastic resin, preferably, a cured product (solidified) of thermosetting resin. The thermosetting resin is preferably cured at a temperature lower than the melting point of the first release member 3. When the thermosetting resin can be cured at a temperature lower than the melting point of the first release member 3, when the filler-resin composite 1 is produced, the first release member 3 can be prevented from melting with heat and integrated with the thermosetting resin, and the thermosetting resin can be cured while being laminated (ref: FIG. 4C).

To be specific, the curing temperature of the thermosetting resin is, for example, preferably 300° C. or less, more preferably 250° C. or less. The thermosetting resin has a curing temperature of, for example, preferably 100° C. or more. When the thermosetting resin has a curing temperature of the above-described lower limit value and the above-described upper limit value or less, the thermosetting resin can be cured at a temperature lower than the melting point of the first release member 3, the first release member 3 can be prevented from melting to be integrated with the thermosetting resin, and the thermosetting resin can be cured.

Examples of the thermosetting resin include thermosetting elastomers such as fluorine rubber, silicone rubber, urethane rubber, butyl rubber, and acrylic rubber; epoxy resin; polyimide resin; phenol resin; urea resin; melamine resin; and unsaturated polyester resin. The thermosetting resin is preferably thermosetting elastomer, more preferably, fluorine rubber.

The second resin layer 7 fills the other end portion of the filler layer 5 in the thickness direction. Preferably, the other end portion of the filler layer 5 in the thickness direction is exposed from the second resin layer 7, and preferably shares (flush with) the same surface. In other words, the other end portion of the filler layer 5 in the thickness direction coincides with the interface between the second resin layer 7 and the second release member 4. The second resin layer 7 has the same functions with those of the first resin layer 6. By including the first resin layer 6 and the second resin layer 7 both in the filler-resin composite layer 2, the filler can be constrained more reliably. The second resin layer 7 is also a cured product of the same thermosetting resin, as is the case with the first resin layer 6, and has a similar thickness with the first resin layer 6. The second resin layer 7 can be spaced apart (separated) from the first resin layer 6, or the first resin layer 6 can be integrated with the second resin layer 7 in the thickness direction.

When the first resin layer 6 is integrated with the second resin layer 7, by pressing the filler layer 5 into resin under reduced pressure or vacuum, the inside of the filler layer 5 can be filled with the resin without resistance of air contained in the filler layer 5.

The first release member 3 is provided for improving handleability of the filler-resin composite layer 2. The first release member 3 is laminated on the first resin layer 6 of the filler-resin composite layer 2. The first release member 3 can be released from the first resin layer 6 of the filler-resin composite layer 2 when the filler-resin composite 1 is used at appropriate timing. The first release member 3 does not include a growth substrate for carbon nanotube.

The first release member 3 contacts one side surface in the thickness direction of the filler-resin composite layer 2 while being laminated on the filler-resin composite layer 2. The first release member 3 is attached to the filler-resin composite layer 2 with pressure-sensitive adhesiveness of the first resin layer 6 when the first resin layer 6 has pressure-sensitive adhesiveness.

The first release member 3 covers one end portion in the thickness direction of the filler layer 5 and the first resin layer 6 while being laminated on the filler-resin composite layer 2. Preferably, the first release member 3 covers the entire one end portion in the thickness direction of the filler layer 5, and the first resin layer 6. In this manner, the first release member 3 protects the one end portion in the thickness direction of the filler layer 5, and the first resin layer 6 while being laminated on the filler-resin composite layer 2.

The first release member 3 supports the filler-resin composite layer 2 so that the filler-resin composite layer 2 is not wrinkled while laminated on the filler-resin composite layer 2.

The first release member 3 preferably has a melting point higher than that of the curing temperature of the above-described thermosetting resin. Examples of the material for the first release member 3 include fluorine resin such as a tetrafluoroethylene.perfluoro alkylvinylether copolymer (PFA), polytetrafluoroethylene (PTFE), tetrafluoroethylene.hexafluoropropylene copolymer (FEP), and polychloro trifluoro ethylene (PCTFE); and silicone resin. By using a material having a melting point higher than the curing temperature of the thermosetting resin as a material for the first release member 3, when producing the filler-resin composite 1, the first release member 3 can be prevented from melting with heat and integrated with the thermosetting resin.

The first release member 3 has a sheet shape extending in a direction orthogonal to the thickness direction of the filler layer 5. The thickness of the first release member 3 can be suitably set in view of rigidity that allows supporting of the filler-resin composite layer 2 while being laminated on the filler-resin composite layer 2, and handleability when the first release member 3 is released from the filler-resin composite layer 2.

To be specific, the first release member 3 has a thickness of, for example, preferably 20 μm or more, and 1000 μm or less. When the first release member 3 has a thickness of the above-described lower limit value or more and the above-described upper limit value or less, handleability of the first release member 3 can be improved.

The second release member 4 is laminated on the second resin layer 7 of the filler-resin composite layer 2. The second release member 4 has the same functions as those of the first release member 3. The second release member 4 covers the other end portion of the filler layer 5 in the thickness direction, and the second resin layer 7. The second release member 4 can be released from the second resin layer 7 of the filler-resin composite layer 2, as in the case with the first release member 3, when the filler-resin composite 1 is used, at an appropriate timing. The second release member 4 also does not include a growth substrate for carbon nanotube, as with the case with the first release member 3. The material and shape of the second release member 4 are the same as those of the first release member 3.

(Method for Using a Filler-Resin Composite)

A method for using the filler-resin composite 1 is described next.

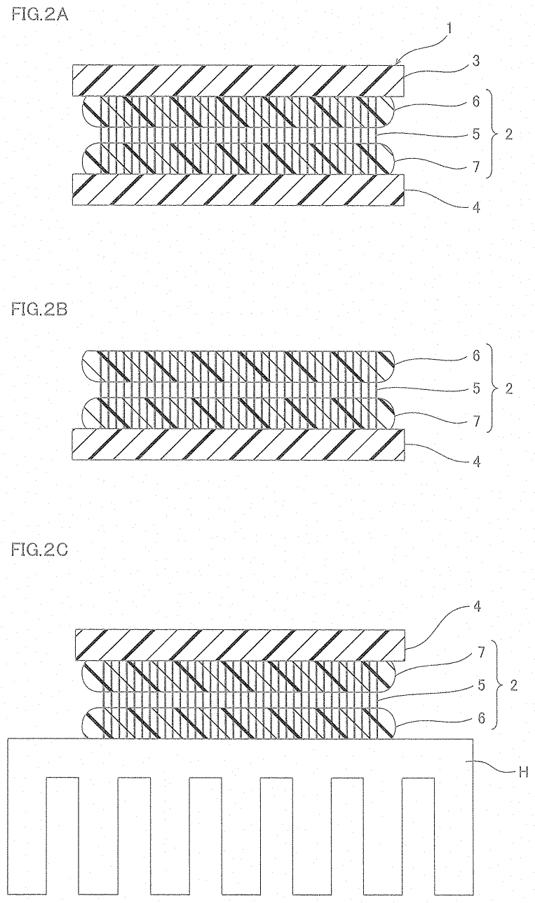

The filler-resin composite layer 2 of the filler-resin composite 1 shown in FIG. 2A is used as a thermal conductive sheet when it has thermal conductivity in the thickness direction.

In this case, first, as shown in FIG. 2B, a handler releases the first release member 3 from the filler-resin composite layer 2 (release step). That is, the first release member 3 can be released from the filler-resin composite layer 2 under normal temperature. In this manner, one end portion in the thickness direction of the filler layer 5 and the first resin layer 6 are exposed. At this time, the second release member 4 is remained at the other side surface in the thickness direction of the filler-resin composite layer 2. Therefore, the handler can handle the filler-resin composite layer 2 supported with the second release member 4, and compared with the case where only the filler-resin composite layer 2 is handled, the filler-resin composite layer 2 can be handled smoothly.

Then, as shown in FIG. 2C, one side surface in the thickness direction of the filler-resin composite layer 2 is allowed to contact the heat sink H. At this time, by pressure-sensitive adhesiveness of the first resin layer 6, the filler-resin composite layer 2 is attached to the heat sink H (member) (attaching step). At this time, the filler is constrained by the first resin layer 6, and therefore the filler can reliably contact the heat sink H at one end portion in the thickness direction of the filler layer 5.

In particular, the distal end portion of the vertically-aligned carbon nanotube may bend by external force. Meanwhile, with the filler-resin composite layer 2 of the present invention, the distal end of carbon nanotube is constrained with the first resin layer 6 at the one end portion of the vertically-aligned carbon nanotube (filler layer 5) in the thickness direction, and therefore it does not bend by external force, and can reliably contact the heat sink H.

Then, as shown in FIG. 3A, the handler releases the second release member 4 from the filler-resin composite layer 2 (release step). That is, the second release member 4 can be released from the filler-resin composite layer 2 under normal temperature. In this manner, the other end portion in the thickness direction of the filler layer 5 and the second resin layer 7 are exposed.

Then, as shown in FIG. 3B, the handler allows a heating element E (member) such as an electronic element to contact the other side surface in the thickness direction of the filler-resin composite layer 2. At this time, by pressure-sensitive adhesiveness of the second resin layer 7, the heating element E is attached to the filler-resin composite layer 2 (attaching means). At this time, the filler is constrained by the second resin layer 7 at the other end portion in the thickness direction of the filler layer 5, and therefore the filler can reliably contact the heating element E.

By the filler making contact with the heat sink H and heating element E reliably, the filler-resin composite layer 2 can conduct heat from the heating element E to the heat sink H efficiently.

(Operations and Effects of the Filler-Resin Composite)

As shown in FIG. 1, with the filler-resin composite 1, the first release member 3 covering the one end portion in the thickness direction of the filler layer 5 and the first resin layer 6 and is releasable from the filler-resin composite layer 2, and the second release member 4 covering the other end portion in the thickness direction of the filler layer 5 and the second resin layer 7 and is releasable from the filler-resin composite layer 2 are laminated on the layer filler-resin composite layer 2 including the filler layer 5, first resin layer 6 filling one end portion in the thickness direction of the filler layer 5, and the second resin layer 7 filling the other end portion in the thickness direction of the filler layer 5.

Therefore, before using the filler-resin composite layer 2, the first release member 3 and the second release member 4 can support the filler-resin composite layer 2, and one end portion in the thickness direction of the filler layer 5, first resin layer 6, the other end portion in the thickness direction of the filler layer 5, and the second resin layer 7 can be protected.

In this manner, before using the filler-resin composite layer 2, the first release member 3 and second release member 4 protect the filler-resin composite layer 2, and therefore the filler-resin composite layer 2 can be prevented from external contamination and damages, and handleability of the filler-resin composite layer 2 before use can be improved, in particular, transportability can be improved.

As shown in FIG. 2B, when the filler-resin composite layer 2 is used, by releasing the first release member 3 from the filler-resin composite layer 2, the one end portion of the filler layer in the thickness direction and the first resin layer 6 can be easily exposed, and as shown in FIG. 3A, by releasing the second release member 4 from the filler-resin composite layer 2, the other end portion of the filler layer in the thickness direction and the second resin layer 7 can be easily exposed.

(Method for Producing Filler-Resin Composite)

The method for producing the filler-resin composite 1 is described.

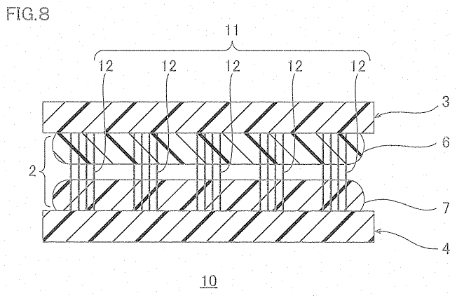

The method for producing the filler-resin composite 1 includes a first preparation step (ref: FIG. 4A), second preparation step (ref: FIG. 4B), lamination step (ref: FIG. 4C), and a curing step (ref: FIG. 5A and FIG. 5B) as an embodiment of the solidifying step.

As shown in FIG. 4A, first, in the first preparation step, a filler layer 5 is prepared. When the filler layer 5 is vertically-aligned carbon nanotube, the vertically-aligned carbon nanotube is produced in the same manner as the carbon nanotube assembly described in Example 1 of WO 2016/136825. Then, after producing the vertically-aligned carbon nanotube, the growth substrate is removed from the vertically-aligned carbon nanotube.

Then, as shown in FIG. 4B, in the second preparation step, the first release member 3 to which the thermosetting resin 8 (an example of resin) is applied, and the second release member 4 to which the thermosetting resin 8 is applied are prepared.

The thickness of the thermosetting resin 8 can be suitably adjusted, but for example, it is preferably 5 μm or more and 10 μm or less. When the thermosetting resin 8 has a thickness of the above-described lower limit value or more and the above-described upper limit value or less, the thickness of the thermosetting resin 8 can be made smaller than the thickness of the filler layer 5 to allow the distal end of the filler layer 5 to easily expose from the thermosetting resin 8.

At this time, a curing agent or a vulcanization agent is blended to the thermosetting resin 8. The thermosetting resin 8 is in B-stage, and is solid.

Then, in the lamination step, as shown in FIG. 4C, the first release member 3 is laminated on the filler layer 5 so that the thermosetting resin 8 contacts the one end portion in the thickness direction of the filler layer 5, and the second release member 4 is laminated on the filler layer 5 so that the thermosetting resin 8 contacts the other end portion in the thickness direction of the filler layer 5.

Then, in the curing step, the thermosetting resin 8 is cured at a temperature lower than the melting point of the first release member 3 to form the first resin layer 6 and the second resin layer 7.

To be specific, in the curing step, the laminate (laminate of filler layer 5, thermosetting resin 8, first release member 3, and second release member 4) produced in the lamination step is pressed in the thickness direction, and heated at a temperature lower than the melting point of the first release member 3 and the second release member 4, and higher than the curing temperature of the thermosetting resin 8.

The laminate can be pressed at a pressure of, for example, preferably 0.1 MPa or more and 1.0 MPa or less. When the laminate is pressed at a pressure of the above-described lower limit value or more and the above-described upper limit value or less, for example, when the filler layer 5 is vertically-aligned carbon nanotube, distal end of the filler layer 5 can be exposed from the thermosetting resin 8 without damaging the vertically-aligned carbon nanotube.

The temperature for heating the laminate is, for example, preferably 150° C. or more and 250° C. or less. When the temperature for heating the laminate is the above-described lower limit value or more and the above-described upper limit value or less, the thermosetting resin 8 can be cured at a temperature lower than the melting point of the first release member 3 and the second release member 4, and the first release member 3 and second release member 4 can be prevented from melting with heat and integrated with the thermosetting resin 8.

Then, as shown in FIG. 5A, the thermosetting resin 8 in B-stage melts and liquefies.

At this time, the liquified thermosetting resin 8 permeates into the one end portion in the thickness direction of the filler layer 5, and the other end portion in the thickness direction of the filler layer 5. In this manner, the one end portion in the thickness direction of the filler layer 5 and the other end portion in the thickness direction of the filler layer 5 are impregnated with the thermosetting resin 8.

At this time, the one end portion in the thickness direction of the filler layer 5 contacts the first release member 3. That is, the one end portion in the thickness direction of the filler layer 5 coincides with the interface between the first release member 3 and the thermosetting resin 8. The other end portion in the thickness direction of the filler layer 5 contacts the second release member 4. That is, the other end portion in the thickness direction of filler layer 5 coincides with the interface between the thermosetting resin 8 and the second release member 4. In this manner, the distal end of the filler is exposed from the thermosetting resin 8 at one end portion in the thickness direction of the filler layer 5.

Then, the laminate is further heated at a temperature lower than the melting point of the first release member 3 and the second release member 4 and the curing temperature or more of the thermosetting resin 8 while the distal end of the filler is exposed from the thermosetting resin 8, as shown in FIG. 5B, and the thermosetting resin 8 is cured and be in C-stage. In this manner, the first resin layer 6 and second resin layer 7 are formed.

The production of the filler-resin composite 1 is completed in this manner. With this production method, the distal end of the filler can be easily exposed from resin at one end portion of the filler layer.

### Modified Example of First Embodiment

In the above-described first embodiment, the filler-resin composite layer 2 includes the resin layer (first resin layer 6, second resin layer 7) at both ends in the thickness direction. The filler-resin composite 1 includes the first release member 3 covering one side surface in the thickness direction of the filler-resin composite layer 2, and the second release member 4 covering the other side surface in the thickness direction of the filler-resin composite layer 2.

In contrast, as shown in FIG. 6, in the modified example, the filler-resin composite layer 2 includes the resin layer 6 at one end portion (one end portion in the thickness direction) in the thickness direction, and no resin layer has to be provided at the other end portion (the other end portion in the thickness direction). In this case, the filler-resin composite 1 includes the release member 3 covering the one side in the thickness direction of the filler-resin composite layer 2, and does not have to include the release member covering the other side surface in the thickness direction of the filler-resin composite layer 2.

In this case, in the second preparation step, one release member 3 to which thermosetting resin 8 is applied is prepared. Then, as shown in FIG. 7A, in the lamination step, the release member 3 is laminated on the filler layer 5 so that the thermosetting resin 8 contacts the one end portion in the thickness direction of the filler layer 5. Thereafter, in the curing step, in the same manner as in the above-described embodiment, while pressing the laminate (laminate of filler layer 5, thermosetting resin 8, and release member 3) in the thickness direction, it is heated at a temperature lower than the melting point of the release member 3 and at the curing temperature or more of the thermosetting resin 8 to cure the thermosetting resin 8, and to form the resin layer 6 as shown in FIG. 7B.

### Second Embodiment

FIG. 8 is a schematic diagram illustrating the configuration of the filler-resin composite 10 in the second embodiment of the present invention. In the second embodiment, the same members as those in the above-described first embodiment are given the same reference numerals, and descriptions thereof are omitted.

In the second embodiment, the filler resin composite 10 includes the filler layer 11.

The filler layer 11 includes a plurality of filler assemblies 12 that are separated from each other. The filler layer 11 has a predetermined pattern formed by the plurality of filler assemblies 12. Examples of the predetermined pattern include a pattern in which the plurality of filler assembles 12 separated from each other are arranged in dots. The filler assembly 12 is an assembly in which the plurality of fillers are densely assembled. Examples of the filler include those fillers given as examples in the above-described first embodiment. Preferably, the filler layer 11 is vertically-aligned carbon nanotube having a predetermined pattern.

The same operations and effects as those of the filler-resin composite 1 in the first embodiment can be achieved with the filler-resin composite 10 in the second embodiment.

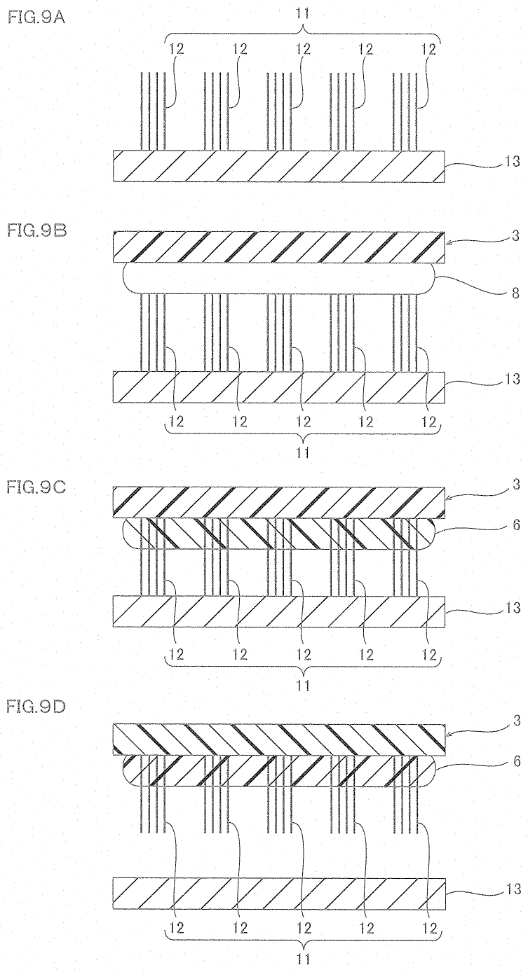

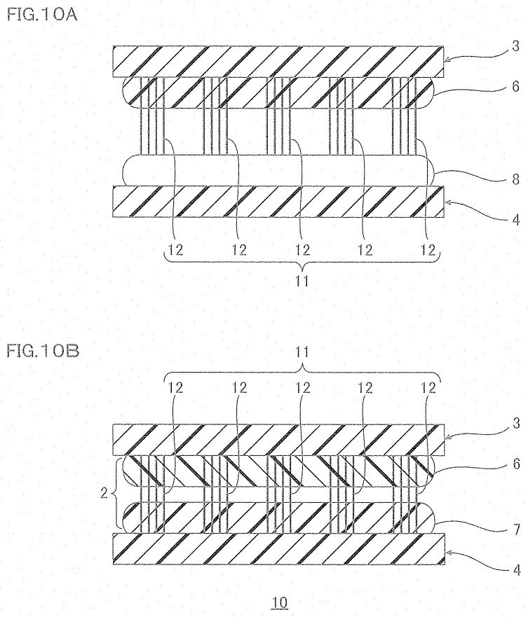

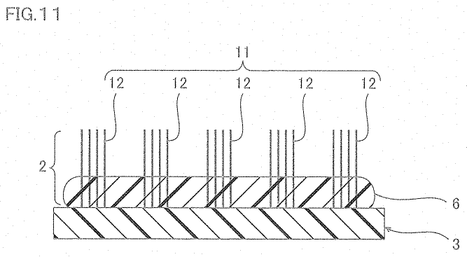

Next, with reference to FIG. 9A to FIG. 10B, a method for producing the filler-resin composite 10 in the second embodiment is described.

The method for producing the filler-resin composite 10 include a preparation step (ref: FIG. 9A), first lamination step (ref: FIG. 9B), first curing step (first solidifying step, ref: FIG. 9C), substrate removal step (ref: FIG. 9 D), second lamination step (ref: FIG. 10A), and second curing step (second solidifying step, ref: FIG. 10B).

As shown in FIG. 9A, first, in the preparation step, a filler layer 11 is prepared. For example, when the filler layer 11 is vertically-aligned carbon nanotube having a predetermined pattern, vertically-aligned carbon nanotube having a predetermined pattern is formed on a growth substrate 13 as an example of the substrate. The predetermined pattern is formed by the plurality of filler assemblies 12 that are separated from each other. One end portion in the thickness direction of the filler layer 11 is disposed at the opposite side of the growth substrate 13 relative to the other end portion in the thickness direction of the filler layer 11. The other end portion in the thickness direction of the filler layer 11 is in contact with the growth substrate 13. In the first embodiment, the growth substrate is removed from the vertically-aligned carbon nanotube, but in the second embodiment, the growth substrate 13 is not removed to keep the predetermined pattern. To keep the predetermined pattern, as described above, the vertically-aligned carbon nanotube can be coated with a metal thin film to increase strength.

Then, in the first lamination step, as shown in FIG. 9B, a first release member 3 to which a thermosetting resin 8 in B-stage is applied is laminated on the filler layer 11 so that the thermosetting resin 8 contacts one end portion in the thickness direction of the filler layer 11. The first release member 3 is laminated at the opposite side of the growth substrate 13 relative to the filler layer 11.

Then, in the first curing step, the thermosetting resin 8 is cured (solidified) at a temperature lower than the melting point of the first release member 3 to form a first resin layer 6.

To be specific, in the first curing step, while pressing the laminate (laminate of growth substrate 13, filler layer 11, thermosetting resin 8, and first release member 3) produced in the first lamination step in the thickness direction, it is heated at a temperature lower than the melting point of the first release member 3 and at the curing temperature or more of the thermosetting resin 8.

The pressure for pressing the laminate, and the temperature for heating the laminate are the same as the above-described first embodiment.

At this time, the thermosetting resin 8 in B-stage melts and liquefies, and the one end portion in the thickness direction of the filler layer 11 is impregnated with the liquefied thermosetting resin 8.

At this time, the one end portion in the thickness direction of the filler layer 11 contacts the first release member 3. That is, the one end portion in the thickness direction of the filler layer 11 coincides with the interface between the thermosetting resin 8 and the first release member 3. In this manner, distal end of the filler is exposed from the thermosetting resin 8 at one end portion in the thickness direction of the filler layer 11.

Then, while exposing the distal end of the filler from the thermosetting resin 8, the laminate is further heated at a temperature lower than the melting point of the first release member 3 and second release member 4, and at the curing temperature of the thermosetting resin 8 or more, the thermosetting resin 8 is cured and be in C-stage. In this manner, as shown in FIG. 9C, the first resin layer 6 is formed at one end portion in the thickness direction of the filler layer 11.

Then, in the substrate removal step, as shown in FIG. 9D, the growth substrate 13 is removed. For example, a cutter edge is moved along the growth substrate 13 to cut out the filler layer 11 from the growth substrate 13.

Then, in the second lamination step, as shown in FIG. 10A, the second release member 4 to which the thermosetting resin 8 in B-stage is applied is laminated on the filler layer 11 so that the thermosetting resin 8 contacts the other end portion in the thickness direction of the filler layer 11. The second release member 4 is laminated on the opposite side of the first release member 3 relative to the filler layer 11.

Then, in the second curing step, as shown in FIG. 10B, in the same manner as in the first curing step, the thermosetting resin 8 is cured (solidified) at a temperature lower than the melting point of the first release member 3 and second release member 4 to form the second resin layer 7 at the other end portion in the thickness direction of the filler layer 11. At this time, the distal end of the filler is exposed from the second resin layer 7 at the other end portion in the thickness direction of the filler layer 11.

The production of the filler-resin composite 10 is completed in the above described manner. With the production method, even when the filler layer 11 includes the plurality of filler assemblies 12 that are separated from each other, the distal end of the filler can be easily exposed from the resin at one end portion and the other end portion of the filler layer 11.

### Modified Example of Second Embodiment

In the above-described second embodiment, the filler-resin composite layer 2 includes the resin layer (first resin layer 6, second resin layer 7) at both ends in the thickness direction. The filler-resin composite 10 includes the first release member 3 covering the one side surface in the thickness direction of the filler-resin composite layer 2, and the second release member 4 covering the other side surface in the thickness direction of the filler-resin composite layer 2.

In contrast, as shown in FIG. 11, in the modified example, the filler-resin composite layer 2 includes the resin layer 6 at one end portion in the thickness direction (one end portion in the thickness direction), and does not have to include the resin layer at the other end portion (the other end portion in the thickness direction). In this case, the filler-resin composite 1 includes the release member 3 covering the one side surface in the thickness direction of the filler-resin composite layer 2, and does not have to include the release member covering the other side surface in the thickness direction of the filler-resin composite layer 2.

### Other Modified Example

In the above-described first embodiment and second embodiment, description is given for the curing step in which a thermosetting resin is used as an embodiment of the solidifying step, but thermoplastic resin can also be used.

### EXAMPLES

The present invention is further described in detail based on EXAMPLES and COMPARATIVE EXAMPLES below. But the present invention is not limited to these Examples. In the following description, parts and % are by mass unless otherwise specified. The specific numerical values of mixing ratio (content), physical property value, and parameter used in the description below can be replaced with the upper limit values (numerical values defined with “or less” or “below”) or lower limit values (numerical values defined with “or more” or “more than”) of the corresponding numerical values of mixing ratio (content), physical property value, and parameter described in “DESCRIPTION OF EMBODIMENTS” above.

### Production of Filler-Resin Composite

### Example 1

Vertically-aligned carbon nanotube (filler layer) having a thickness of 100 μm was produced in accordance with the method for carbon nanotube assembly (before heating) described in Example 1 of WO2016/136825, and the growth substrate was removed (first preparation step).

Then, two PFA sheets having a thickness of 50 μm (melting point: 310° C.) were prepared as the first and second release members, and fluorine rubber (thermosetting resin, trade name: Viton, manufactured by DuPont, vulcanization temperature: 170-200° C.) in which a vulcanization agent was blended was applied to the PFA sheets so that the application thickness was 20 μm (second preparation step).

Then, one of the PFA sheets was laminated on the vertically-aligned carbon nanotube so that the one end portion in the thickness direction of vertically-aligned carbon nanotube faced the fluorine rubber, and the other of the PFA sheets was laminated on the vertically-aligned carbon nanotube so that the other end portion in the thickness direction of vertically-aligned carbon nanotube faced fluorine rubber (lamination step).

Then, while pressing the produced laminate in the thickness direction with a pressure of 0.5 MPa, it was heated at 200° C. for 10 minutes (curing step).

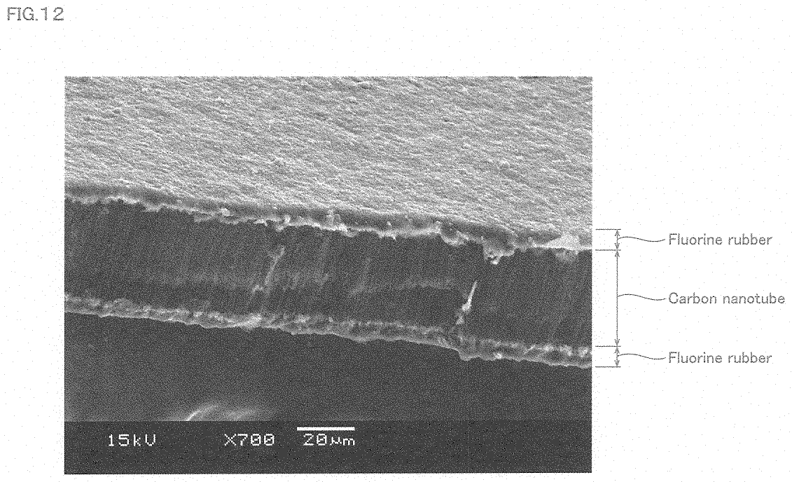

The fluorine rubber was cured, and the filler-resin composite was produced in this manner. A scanning electron microscope image of the filler-resin composite layer (thermal conductive sheet) of the produced filler-resin composite is shown in FIG. 12.

### Example 2

A filler-resin composite was produced in the same manner as in Example 1, except that the vertically-aligned carbon nanotube was produced in the same manner as in the method for highly dense carbon nanotube assembly (after heating) described in Example 1 of WO2016/136825.

### Example 3

A filler-resin composite was produced in the same manner as in Example 1, except that silicone rubber was used instead of fluorine rubber.

### Example 4

A filler-resin composite was produced in the same manner as in Example 1, except that urethane rubber was used instead of fluorine rubber.

### Example 5

A filler-resin composite was produced in the same manner as in Example 1, except that a PTFE sheet was used instead of the PFA sheet.

### Example 6

A filler-resin composite was produced in the same manner as in Example 1, except that a FEP sheet was used instead of the PFA sheet.

### Example 7

A filler-resin composite was produced in the same manner as in Example 1, except that a PCTFE sheet was used instead of the PFA sheet.

### Example 8

A filler-resin composite was produced in the same manner as in Example 1, except that a silicone resin sheet was used instead of the PFA sheet.

### Example 9

A filler-resin composite was produced in the same manner as in Example 1, except that a PFA sheet having a thickness of 100 μm was used.

### Example 10

A filler-resin composite was produced in the same manner as in Example 1, except that a PFA sheet having a thickness of 200 μm was used.

(Handleability)

Releasability of the release member and handleability of the filler-resin composite layer (thermal conductive sheet) were evaluated for the filler-resin composite produced in Examples.

In any of Examples, the release member could be released easily from the filler-resin composite layer, and even after releasing the release member, it was handled smoothly without loosening the vertically-aligned carbon nanotube.

(Thermal Resistance Measurement)

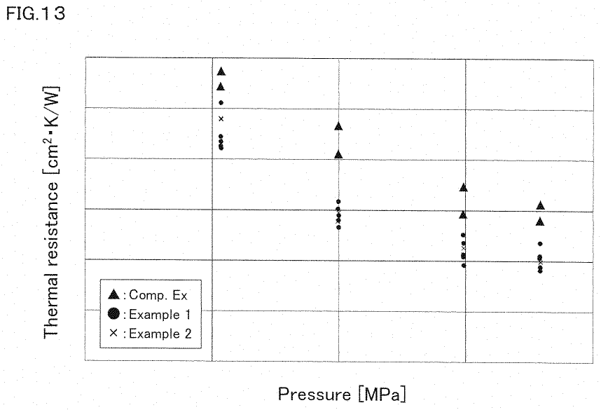

The thermal resistance at several points was measured by changing the pressure in the thickness direction for Comparative Example (thermal conductive sheet composed only of vertically-aligned carbon nanotube of Example 1) and the filler-resin composite layer (thermal conductive sheet) of the filler-resin composite produced in Example 1 and Example 2 using a thermal resistance measurement device (trade name: T3Ster DynTIM Tester, manufactured by Mentor Graphics Corp). The results are shown in FIG. 13.

The thermal resistance was lower (higher thermal conductivity) in Example 1 and Example 2 compared with Comparative Example. This is probably because the distal end of the carbon nanotube is constrained by the first resin layer, it contacts the thermal resistance measurement device reliably without being bent by external force.

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The filler-resin composite of the present invention can be used as, for example, a thermal conductive sheet, to be specific, a thermal conductive sheet for conducting heat from a heating element to a heat sink.

### DESCRIPTION OF REFERENCE NUMERALS

1 filler-resin composite
2 filler-resin composite layer
3 first release member
4 second release member
5 filler layer
6 first resin layer
7 second resin layer
8 thermosetting resin

1. A filler-resin composite comprising:
a filler layer in which filler is assembled,
a resin layer in which resin is charged in at least one end portion of the filler layer in the thickness direction and a distal end of the one end portion of the filler layer is exposed, and
a release member laminated on the resin layer,
wherein
the release member can be released from the resin layer.

2. The filler-resin composite according to claim 1, wherein
the resin layer is separately charged at one end portion and the other end portion of the filler layer in the thickness direction, and
the release member is laminated on the one end portion and the other end portion of the resin layer.

3. The filler-resin composite of claim 1, wherein
the filler layer is vertically-aligned carbon nanotube.

4. A method for producing a filler-resin composite, the method including the steps of:
a first preparation step, in which a filler layer is prepared,
a second preparation step, in which a release member to which resin is applied is prepared,
a lamination step, in which the release member is laminated on the filler layer so that the resin contacts at least one end portion of the filler layer in the thickness direction, and
a solidifying step, in which a distal end of the one end portion of the filler layer is exposed, and the resin is solidified to form a resin layer.

5. A method for producing a filler-resin composite, the method including the steps of:
a first preparation step, in which a filler layer is prepared,
a second preparation step, in which a release member to which resin is applied, and a second release member to which resin is applied are prepared,
a lamination step, in which the release member is laminated on the filler layer so that the resin of the release member contacts one end portion of the filler layer in the thickness direction, and the second release member is laminated on the filler layer so that the resin of the second release member contacts the other end portion of the filler layer in the thickness direction, and
a solidifying step, in which the distal end of the one end portion and the other end portion of the filler layer is exposed, and the resin is solidified to form a resin layer at the one end portion and the other end portion of the filler layer in the thickness direction.

6. A method for producing a filler-resin composite, the method including the steps of:
a preparation step, in which a filler layer is prepared on a substrate,
a first lamination step, in which a first release member to which resin is applied is laminated on the opposite side of the substrate relative to the filler layer so that the resin contacts one end portion of the filler layer in the thickness direction,
a first solidifying step, in which the distal end of the one end portion of the filler layer is exposed, and the resin is solidified to form a resin layer at the one end portion of the filler layer in the thickness direction, and
a substrate removal step, in which the substrate is removed.

7. The method for producing a filler-resin composite according to claim 6, the method including the steps of:
a second lamination step, in which a second release member to which resin is applied is laminated on the opposite side of the first release member relative to the filler layer so that the resin contacts the other end portion of the filler layer in the thickness direction, and
a second solidifying step, in which a distal end of the other end portion of the filler layer is exposed, and the resin is solidified to form a resin layer on the other end portion of the filler layer in the thickness direction.

8. A filler-resin composite layer comprising:
a filler layer, and
a first resin layer, in which resin is charged in at least one end portion of the filler layer in the thickness direction and a distal end of the one end portion of the filler layer is exposed,
wherein the distal end of the one end portion of the filler layer is flush with the interface of the first resin layer.

9. The filler-resin composite layer according to claim 8, further including
a second resin layer, in which resin is charged in the other end portion of the filler layer in the thickness direction and the distal end of the other end portion of the filler layer is exposed,
a distal end of the other end portion of the filler layer is flush with the interface of the second resin layer, and
the first resin layer is separated from the second resin layer at one end portion and the other end portion of the filler layer in the thickness direction.

10. A method for using a filler-resin composite,
being a method for using the filler-resin composite according to claim 1, the method including the steps of:
a release step, in which the release member is released from the resin layer, and
an attaching step, in which the released resin layer having pressure-sensitive adhesiveness is attached to a member.

11. The filler-resin composite of claim 2, wherein
the filler layer is vertically-aligned carbon nanotube.
